(19) United States
(12) Patent Application Publication
(10) Pub. No.: US 2010/0282998 A1
(43) Pub. Date: Nov. 11, 2010

(54) POLY(3,4-ETHYLENEDIOXYTHIOPHENE)

(76) Inventors: H. V. Rasika Dias, Arlington, TX (US); Milan K. Dissanayake Mudiyanselage, St. Gallen (CH)

Correspondence Address: Parks IP Law / UTA, 1117 Perimeter Center West, Suite E402, Atlanta, GA, 30338, US

(21) Appl. No.: 12/274,745

(22) Filed: Nov. 20, 2008

Related U.S. Application Data
(60) Provisional application No. 61/004,669, filed on Nov. 28, 2007.

(51) Int. Cl. C08L 41/00

(52) U.S. Cl. 252/62.2

(57) ABSTRACT

The present invention relates to a method of synthesizing poly(3,4-ethylenedioxythiophene), PEDOT in a reaction medium, an acid, an oxidant and an aqueous polyelectrolyte, and compositions thereof. The method is non-stoichiometric and provides no by-products, except water, or solid waste requiring post treatment. The method provides high yields of a composition that exhibits high conductivity.

### CROSS-REFERENCE TO RELATED APPLICATIONS

This application claims priority to U.S. Application No. 61/004,669, filed Nov. 28, 2007, the entirety of which is herein incorporated by reference.

### STATEMENT REGARDING FEDERALLY SPONSORED RESEARCH OR DEVELOPMENT

The U.S. Government has in part a paid-up license in this invention and the right in limited circumstances to require the patent owner to license others on reasonable terms as provided for by the terms of Grant No. CHE-0314666 awarded by the National Science Foundation.

### BACKGROUND

The invention relates generally to the field of polymer chemistry and more particularly to improved methods of synthesizing poly(3,4-ethylenedioxythiophene) and compositions thereof.

There are methods of synthesizing poly(3,4-ethylenedioxythiophene) (“PEDOT”); however, such methods are typically expensive, require harsh chemicals and/or metal ions, require post-treatment and produce non-benign waste.

A polymer precursor of PEDOT is 3,4-ethylenedioxythiophene (“EDOT”). Several polymerization processes for EDOT are available, and the synthesis routes include oxidative chemical polymerization, electrochemical polymerization and transition metal or enzyme catalyzed polymerization. Disadvantages associated with such EDOT polymerization routes are identified in TABLE 1.

TABLE 1

| Method | Disadvantages |
|---|---|
| Chemical | High production cost |
| polymerization | Harmful by-products contaminate final product |
| | Requires disposal of harmful chemicals |
| Electrochemical | Difficult to implement at industrial scale |
| polymerization | High production cost |
| Metal-catalyzed | Reactive catalyst is difficult to handle (e.g., moisture- |
| polymerization | and air-sensitivity) |
| | Catalyst recycling or removal problems |
| | Complicated post treatment procedures |

For example, oxidative chemical polymerization is one of the more common polymerization methods for preparing PEDOT. With this method, EDOT is polymerized in a stoichiometric amount (or more) through consumption of an oxidant, such as FeCl₃, (NH₄)₂S₂O₈, Ce(SO₄)₂, Fe(OTf)₃, (NH₄)₂Ce(NO₃)₆. Unfortunately, this method produces a large quantity of by-products, some of which are very environmental unfriendly. Furthermore, the oxidants themselves are expensive and many are hazardous. Other chemical polymerization procedures require metal salts, thus producing harmful by-products that must be carefully separated from the polymers after polymerization. As such, post-treatment processes for such methods are both complicated and expensive. One commonly used polymerization method for the synthesis of PEDOT is a method developed by Bayer AG. This method requires an expensive oxidant in which EDOT is polymerized in an aqueous polyelectrolyte-polystyrene sulfonate (“PSS”) with sodium or ammonium persulphate as the oxidizing agent.

Presently, the production of PEDOT at industrial scale at a low cost is not feasible. Furthermore, there are no non-stoichiometric methods available to make PEDOT particularly at a large scale. Thus, there is a need for EDOT polymerization process that is both inexpensive and produces little waste and/or harmful by-products.

The invention described herein overcomes one or more disadvantages described above, and provides a simple, reliable, and relatively environmentally friendly and economical method for synthesizing PEDOT having little waste and/or harmful by-products, and compositions thereof. The process produces a high quality, high yield product that is non-stoichiometric and produces no solid waste requiring post-treatment.

### SUMMARY OF THE INVENTION

In one aspect of the invention, as provided herein, is a method of synthesizing poly(3,4-ethylenedioxythiophene) compositions from a 3,4-ethylenedioxythiophene precursor in an aqueous medium in the presence of an acid, an oxidant and an aqueous polyelectrolyte.

In yet another aspect of the invention, the method of synthesizing PEDOT requires no metals or strong chemicals (e.g., those that are environmentally hazardous), such that the by-product generated during synthesis is water; thereby, providing a clean end-product without solid waste or need for a post-treatment.

In another aspect of the invention, the reaction medium used in the process can be recycled as it does not contain components that are harmful (e.g., hazardous) or ones that may negatively interfere with EDOT polymerization.

In yet another aspect of the invention, the synthesis of EDOT is performed at ambient conditions and is suitable for high throughput.

Those skilled in the art will further appreciate the above-noted features and advantages of the invention together with other important aspects thereof upon reading the detailed description that follows in conjunction with the drawings.

### BRIEF DESCRIPTION OF THE FIGURES

For a more complete understanding of the features and advantages described herein, reference is now made to the detailed description of this application along with the accompanying figures, wherein:

FIG. 1 depicts a representative structure of PEDOT/Polystyrenesulfonate (PSS).

FIG. 2 depicts a representative FTIR spectrum of PEDOT/PSS prepared at a ratio of acid:oxidant of about 3:0.5.

FIG. 3 depicts a representative cyclic voltammogram of PEDOT/PSS prepared at a ratio of acid:oxidant of about 3:0.5 in 0.1 M NaCl at 50 mV/sec.

FIG. 4. depicts a representative cyclic voltammogram of PEDOT/PSS, prepared at ratio of HCl to H₂O₂ 3:0.5 and doped with excess PF₆⁻, in 0.1M NaCl at 50 mV s⁻¹

FIG. 5A. depicts representative Nyquist plots of PEDOT/PSS, prepared at ratio of H₂O₂ to HCl to 3:0.5 and doped with PF₆⁻, deposited on ITO electrode at different positive DC potentials.

FIG. 5 B. depicts representative Nyquist plots of PEDOT/PSS, prepared at ratio of HCl to H₂O₂ 3:0.5 and doped with PF₆⁻, deposited on ITO electrode at different negative DC potentials.

FIG. 6. depicts representative UV-Visible spectra of PEDOT/PSS prepared at various molar ratios of HCl to H₂O₂ (□) 3:0.5 () 1:1 (▾) 1:3.

FIG. 7. depicts representative FT-IR spectra of PEDOT/PSS prepared at various molar ratios of HCl to H₂O₂ () 1:1 (▾) 1:3.

### DETAILED DESCRIPTION

The invention, as provided with the claims, may be better understood by reference to the following detailed description. The description is meant to be read with reference to the figures contained herein. This detailed description relates to representative examples of the claimed subject matter for illustrative purposes, and is in no way meant to limit the scope of the invention as described. One or more embodiments discussed herein are merely illustrative of ways to make and use the invention, and do not limit the scope of the invention.

The acronym “PEDOT” refers to poly(3,4-ethylenedioxythiophene). PEDOT is a conducting polymer containing conjugated double bonds. The conjugated polymer acts as a semi-conductor with useful electrical properties. For example, fully integrated circuits, organic light emitting diodes, biosensors, transistors, supercapacitors, other electrical devices, and the like may be made using this conducting polymer.

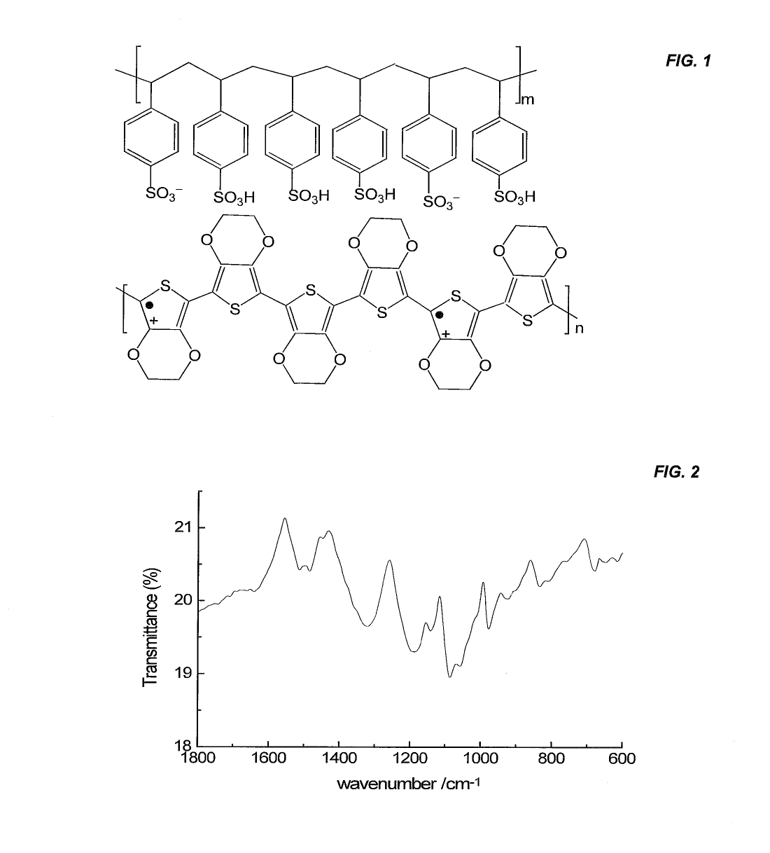

The term “PEDOT-polystyrenesulfonate (PSS) polymer” refers to a conjugated polymer, and a commercially useful form of the conducting polymer. The success of the polymer is due to its stability in a p-doped form, its high conductivity, good film-forming properties, high transparency in a doped state, and a low redox potential. This polymer is one of the most common materials used for hole injecting layers in organic light emitting devices. A representative structure of the polymer is depicted in FIG. 1.

The acronym “EDOT” is a polymer precursor of PEDOT.

The acronym “PSS” stands for polystyrene sulfonate and refers to the aqueous polyelectrolyte used in the present invention.

Described herein is a method of polymerizing EDOT which is dispersed in a suitable reaction medium to produce PEDOT and compositions thereof. More specifically, the method occurs in a reaction medium containing an acid, an oxidant and an aqueous polyelectrolyte.

In one embodiment, the polymerization reaction occurs in the absence of a catalyst typically used with such polymerization processes (e.g., AlCl₃, CuBr₂, [MeB(3-(Mes)Pz)₃]CuCl or an enzyme). This method produces PEDOT in high yield (at or about 85-90% or greater) even in absence of the catalyst.

A preferred aspect of the invention is realized when a very small amount of EDOT, an acid and an oxidant are further dispersed in PSS.

A suitable reaction medium for the present method is pure water.

A preferred oxidant is a strong oxidizer, such as hydrogen peroxide (H₂O₂), which when reduced further forms water and is, thus, absent of harmful by-products and does not require elaborate or costly post-treatment. In addition to hydrogen peroxide as an oxidant, another suitable oxidant is oxygen. Different oxidants will provide different yields. Higher yields are provided by an oxidant such as hydrogen peroxide. A lower yield (at or about 55%) may be provided when using an oxidant such as oxygen. With some oxidants, polymer conductivity is also reduced. For example, when oxygen is used as an oxidant it provides a lower conductivity of at or about 0.00062 S/cm. As such, polymer conditions and activity may be manipulated as desired.

A preferred acid is hydrochloric acid; however, other mild acids such as fluoroboric acid (HBF₄) and the like, may also be suitable.

A comparison of a representative reaction condition described herein (referred to as no-catalyst in TABLE 2) with various known stoichiometric methods are provided in TABLE 2. In TABLE 2, for the no-catalyst reaction condition, the oxidant is hydrogen peroxide, the monomer is EDOT. Reactants for Stoichiometric A, B, and C are provided in TABLE 2. The reaction identified as Stoichiometric A relied on a synthetic route reported by Qi et al. (Chem. Commun. 1998, 2299). The reaction identified as Stoichiometric B relied on a synthetic route reported by Lefebvre et al. (Chem. Mater. 1999, 11, 262). The reaction identified as Stoichiometric C relied on a synthetic route reported by Zhang et al. (Macromolecule 2006, 39, 470).

TABLE 2

| | |
|---|---|
| | Molar ratio |
| Method | Oxidant/Monomer |

| | | |
|---|---|---|
| No-catalyst | H₂O₂/EDOT | 0.50 |
| Stoichiometric A | Fe(NO₃)₃•9H₂O/EDOT | 5.06 |
| Stoichiometric B | Fe(NO₃)₃•9H₂O/EDOT | 5.00 |
| Stoichiometric C | FeCl₃/EDOT | 2.05 |

The invention is further described in connection with the following non-limiting example.

### Preparative Example 1

### Preparation of PEDOT/PSS

3,4-ethylenedioxythiophene (0.7 g, 5 mmol) was dissolved in 10 mL of de-aerated water and hydrochloric acid (36% w/w HCl in water, 1.5 g of solution (0.546 g HCl), 15 mmol of HCl); 30% hydrogen peroxide (0.28 g, 2.5 mmol) was added at room temperature. After about 10 minutes with stirring, 0.2 g of poly(sodium-4-styrenesulfonate), dispersed in 10 mL of water, was added and the mixture stirred for another 24 hours at room temperature. A blue precipitate was obtained and could be separated by filtration, was washed with large amounts of water and dried under reduced pressure. The dried composition was 0.850 g of PEDOT/PSS as a blue precipitate.

### Analysis of PEDOT/PSS:

PEDOT/PSS—potassium bromide (KBr) pellets were prepared using 1 to 20 mass ratio of PEDOT/PSS to KBr for FT-IR spectroscopy. FT-IR spectroscopy and electrochemical analysis as well as UV-visible spectroscopy and bulk conductivity measurements (using a standard four-point probe method) were useful for identifying the physical and chemical properties of the composition. UV visible spectra were recorded on corresponding PEDOT/PSS samples dispersed in water with respect to water. Electrochemical studies were also performed. Conducting PEDOT was synthesized with high yield (85-90%) having a conductivity of 1-2.5 S cm⁻¹.

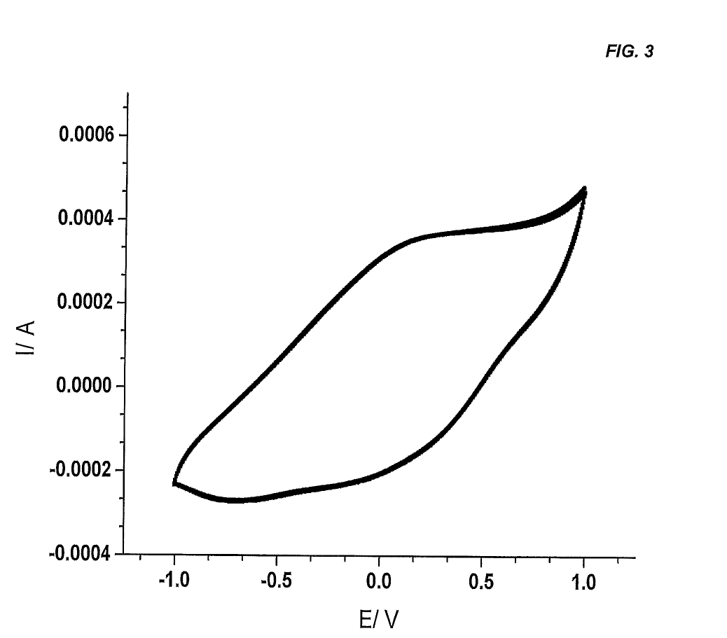

As depicted in FIG. 2, a representative FT-IR spectrum of the synthesized PEDOT/PSS was taken and shows characteristic bands for PEDOT. Still referring to FIG. 2, the band at 2940 cm⁻¹ is due to a C—H stretching vibration band of thiophene and phenyl rings. The band at 1490 cm⁻¹ is a C═C anti-symmetric stretching band. At 1445 cm⁻¹ is C═C symmetric stretching band. At 1187, 1139 and 1086 cm⁻¹ are C—O—C stretching vibration bands. The band at 1340 cm⁻¹ is due to C—C and C═C stretching of a quinoid structure of thiophene while the bands at 977, 835, 685 cm⁻¹ are due to C—S in thiophene.

Appearance of such characteristic peaks of PEDOT/PSS confirms formation of the polymer by the method described herein. UV-visible spectroscopy and electrochemical studies further verified the presence of the polymer. The primary UV absorption bands for PEDOT/PSS were seen at around 230 nm, 235 nm and 800 nm, which is consistent with other reports of similarly formed products.

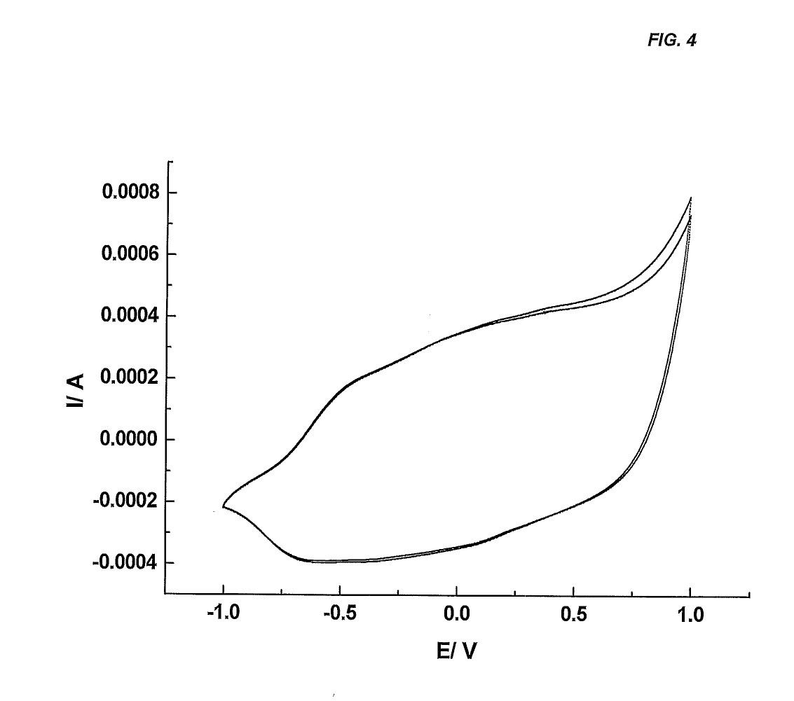

Electrochemical analyses of the composition described herein show that as the potential was swept more positively, the current was raised sharply and peaked at around +0.20 V due to oxidation of the polymer (FIG. 3). Upon potential reversal, the corresponding reduction peak appeared at around −0.70 V (FIG. 3). The inter-conversion of different structural forms could be done repetitively.

The stability of PEDOT/PSS as described herein at high anodic and cathodic potentials was determined electrochemically in a wide potential range. Representative values are depicted in TABLE 3. In addition, electrochemical impedance spectroscopy of resulting PEDOT/PSS material was obtained, as shown. Interestingly, all such materials had the least electronic resistance in the potential range between −200 mV and +200 mV.

TABLE 3

Potential (mV)

| | −200 | −100 | +100 | +200 |
|---|---|---|---|---|
| Electronic Resistance (Ω) | 35 | 45 | 25 | 35 |

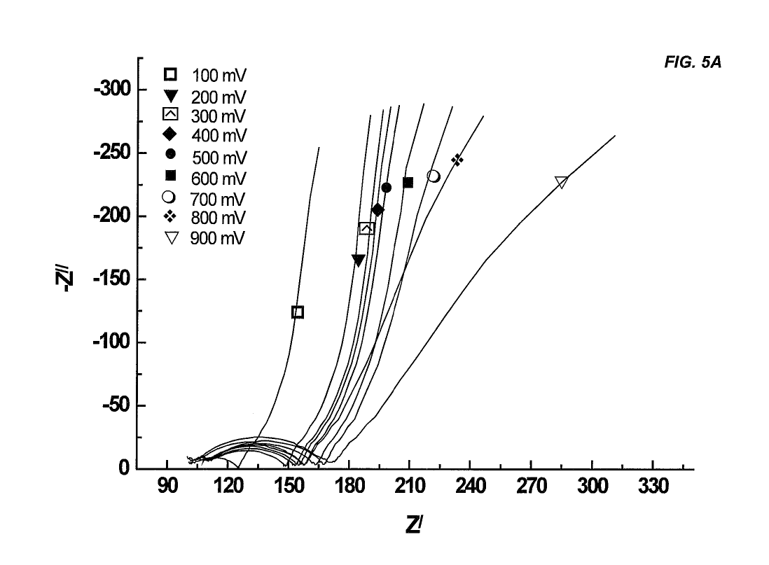

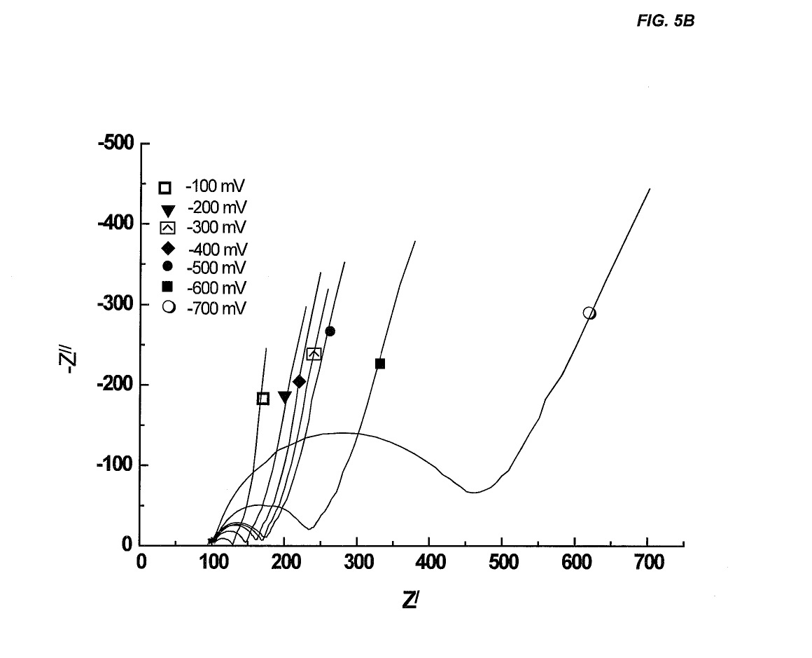

Yield and conductivity of the formed polymers described herein may be manipulated as desired by varying the molar ratio of acid to oxidant. Examples of various conditions in which yield (as dry weight of PEDOT) and bulk conductivity were modified are shown in TABLE 4. Pure H₂O as a reaction medium with HCl and H₂O₂ provided both a high yield and a high conductivity, one that has superior conductivity to that of polymers produced by other alternative methods. Generally, polymer conductivity was tuned by the presence of weakly coordinating anions such as PF₆⁻, I₃⁻, SO₄²⁻, CF₃SO₃⁻. CH₃(CH₂)₁₁C₆H₄SO₃⁻, when used as the dopant. For example, conductivity was enhanced to a value of 2.5 S cm⁻¹ or better by using PF₆⁻ as the dopant. These results are in line with CV (FIG. 4) and EIS (FIGS. 5A & 5B) studies. Shift of the oxidation potential towards the negative potential in cyclic voltammogram give supporting evidence for the enhancement of the conductivity due to increment of the electronic delocalization of the PEDOT. It is worth noting that the electrical property of the material is stable wide range of positive and negative potentials.

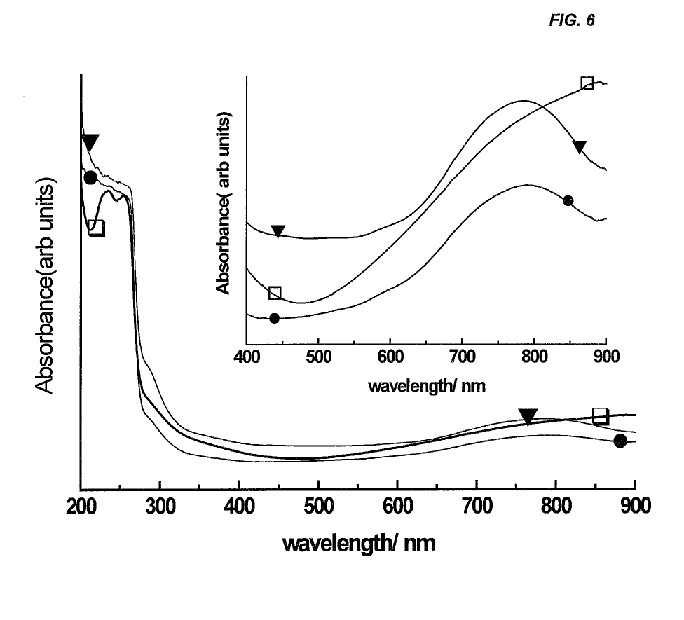

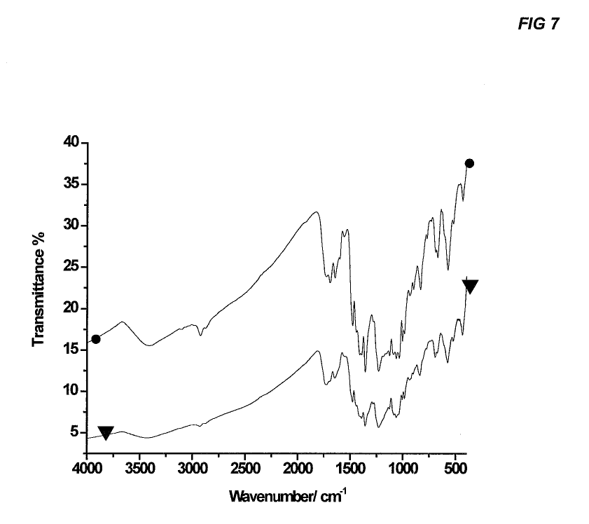

Further, the influence of ratio the number of moles of HCl to H₂O₂ for the formation of PEDOT/PSS is also investigated. The yield and conductivities of the resulting PEDOT/PSS under such conditions are listed in TABLE 4. When the ratio of acid to oxidant is 3:0.5, these samples show significantly high yield and conductivity. However, it can be seen that there are significant changes in these values upon decreasing the ratio and conductivity diminishes when it is 1:3. The reduction of the conductivity is due to over-oxidation of the product, while the yield decrease is likely due to change in the rate of polymerization with the H⁺ concentration of the medium. This is further verified by UV (FIG. 6) FT-IR (FIG. 7) spectroscopic studies.

TABLE 4

| | | EDOT:Oxidant | Dry | Conductivity |
|---|---|---|---|---|
| Medium | Molar Ratio | molar Ratio | weight (g) | (S cm⁻¹) |
| H₂O | 3:0.5 (HCl:H₂O₂) | 2:1 | 0.850 | 1 |
| CH₃OH | 3:0.5 (HCl:H₂O₂) | 2:1 | 0.008 | n/a |
| H₂O | 3:1.5 (HCl:H₂O₂) | 2:3 | 0.900 | 0.0423 |
| H₂O | 3:1 (HCl:H₂O₂) | 1:1 | 0.575 | 0.106 |
| H₂O | 1:1 (HCl:H₂O₂) | 2:1 | 0.438 | 0.0026 |
| H₂O | 1:3 (HCl:H₂O₂) | 2:3 | 0.420 | non- |
| | | | | conducting |
| H₂O | 3:0.5 (HBF₄:H₂O₂) | 2:1 | 0.710 | 0.0025 |

While specific alternatives to steps of the invention have been described herein, additional alternatives not specifically disclosed but known in the art are intended to fall within the scope of the invention. Thus, it is understood that other applications and embodiments will be apparent to those skilled in the art upon reading the described embodiments herein and after consideration of the appended claims and drawings.

What is claimed is:

1. A method of forming a poly(3,4-ethylenedioxythiophene) composition comprising:
reacting 3,4-ethylenedioxythiophene in a reaction medium, an acid, an oxidant and an aqueous polyelectrolyte.

2. The method of claim 1, wherein the acid is hydrochloric acid.

3. The method of claim 1, wherein the acid is fluoroboric acid.

4. The method of claim 1, wherein the oxidant is hydrogen peroxide.

5. The method of claim 1, wherein the reaction medium is pure water.

6. The method of claim 1, wherein the acid to oxidant ratio is about 3:1.5.

7. The method of claim 1, wherein the acid to oxidant ratio is about 3:0.5.

8. The method of claim 1, wherein the ratio of acid to oxidant affects yield.

9. The method of claim 1, wherein the aqueous polyelectrolyte is initially dispersed in water.

10. The method of claim 1, wherein the aqueous polyelectrolyte is poly(sodium-4-styrenesulfonate).

11. The method of claim 1, wherein the method provides no significant waste or harmful by-products.

12. The method of claim 1, wherein the method requires no additional post-treatment of solid waste.

13. The method of claim 1, wherein yield is better than about 85%.

14. The method of claim 8, wherein the yield is adjusted by varying molar ratios of acid to oxidant.

15. A method of forming a poly(3,4-ethylenedioxythiophene) composition, wherein the method is non stoichiometric, provides no significant by-products except water and has a composition yield of about 85% or greater.

16. The method of claim 15, wherein the method requires no additional post-treatment of solid waste.

17. A poly(3,4-ethylenedioxythiophene) composition prepared by a method of reacting 3,4-ethylenedioxythiophene in a reaction medium, an acid, an oxidant and an aqueous polyelectrolyte.

18. The composition of claim 17, wherein the composition is stable at high anodic and cathodic potentials.

19. The composition of claim 17, wherein the composition exhibits low electronic resistance in a potential range between −200 mV and +200 mV.

20. The composition of claim 17, wherein conductivity of the composition is adjusted by varying molar ratios of acid to oxidant.

21. A poly(3,4-ethylenedioxythiophene) composition, wherein the composition is prepared by a method that provides no by-product except water and the composition has a conductivity better than poly(3,4-ethylenedioxythiophene) compositions prepared by alternative methods.

22. The composition of claim 21, wherein the reaction medium is pure water, the acid is hydrochloric acid, and the oxidant is hydrogen peroxide.
